(19) United States
(12) Patent Application Publication
(10) Pub. No.: US 2026/0037963 A1
(43) Pub. Date: Feb. 5, 2026

(54) ADAPTIVE REQUEST HANDLING USING A DYNAMIC SERVER HEALTH SCORE

(71) Applicant: MASTERCARD INTERNATIONAL INCORPORATED, PURCHASE, NY (US)

(72) Inventor: Thiyagarajan VELAPPAN, Katy, TX (US)

(21) Appl. No.: 19/280,042

(22) Filed: Jul. 24, 2025

Related U.S. Application Data
(60) Provisional application No. 63/678,040, filed on Jul. 31, 2024.

(51) Int. Cl. G06Q 20/38

(52) U.S. Cl. CPC G06Q 20/382

(57) ABSTRACT

A system provides a mechanism to identify whether a server is fit to process a transaction request. The system is configured to receive a transaction request from an entity and determine metrics for one or more parameters associated with a server. A health score of the server is computed based on the metrics and determined whether or not the health score of the server meets a criterion. The transaction request is processed by the server based on the health score of the server meeting the criterion. Aspects of the disclosure are also related to determining metrics for each of a plurality of servers for one or more parameters and calculating a health score for each of the plurality of servers. The server having a highest health score may be used for processing the transaction request. The mechanism provides efficiency and reduction in processing latency of the transactions.

### BACKGROUND

Real-time payment processing systems face significant technical challenges in maintaining optimal system performance and reliability under dynamic computational workloads, where distributed computing infrastructure must process transaction requests with stringent sub-second latency requirements across geographically distributed server networks. A technical problem arises from inherent variability in computational load distribution, causing transaction processing servers to experience unpredictable resource utilization patterns that result in system bottlenecks, memory allocation failures, and network congestion. This manifests as increased response latency, reduced system throughput, and potential cascade failures across interconnected processing nodes, leading to system instability when processing volumes exceed predetermined thresholds. Additionally, many existing fault detection and recovery protocols are insufficient for maintaining continuous system availability as they rely on reactive rather than proactive monitoring of hardware and software components, while the technical challenges are compounded by the need for microsecond-level synchronization across distributed database systems where data consistency and transaction integrity must be preserved while maintaining high-frequency data processing capabilities. As a result, some existing system architectures exhibit poor scalability characteristics and cannot efficiently handle the computational demands of modern high-volume transaction processing environments.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A system comprising a processor and at least a memory for processing a transaction request is described. The system is configured to receive a transaction request from an entity and determine metrics for one or more parameters associated with a server. A health score of the server is computed based on the metrics. The system determines whether the health score of the server meets a criterion, and the transaction request is processed by the server based on the health score of the server meeting the criterion. Based on the one or more parameters, a plurality of factors is computed, and the health score is determined by computing one or more factors using a formula.

A system for processing a transaction request by selecting a server from a plurality of servers is also described. The system is configured to determine metrics for one or more parameters for each of a plurality of servers. Health scores for each of the plurality of servers are computed based on the metrics for one or more parameters by averaging and summating the weighted scores of a plurality of factors. The health scores of each of the plurality of servers are then compared to determine the highest health score, and the transaction request is transmitted to a server of the plurality of servers based on the highest health score.

A computer implemented method for processing a transaction request by selecting a server from a plurality of servers is also described. The method is performed to determine metrics for one or more parameters for each of a plurality of servers. Health scores for each of the plurality of servers are computed based on the metrics for one or more parameters. The health scores of each of the plurality of servers are then compared to determine the highest health score, and the transaction request is transmitted to a server of the plurality of servers based on the highest health score.

### BRIEF DESCRIPTION OF THE DRAWINGS

The present description will be better understood from the following detailed description read considering the accompanying drawings, wherein:

FIG. 1 is a block diagram illustrating an exemplary system architecture for processing a transaction request;

FIG. 2 is a block diagram of an example apparatus for processing a transaction request.

FIGS. 3A and 3B illustrate flowcharts for processing of a transaction request according to different aspects of the disclosure;

FIG. 4 is a flowchart illustrating a method of processing a transaction request according to an aspect of the disclosure;

FIG. 5 is a flowchart illustrating a method for processing a transaction request according to another aspect of the disclosure.

FIG. 6 is a run-time example of an aspect of the disclosure.

FIG. 7 illustrates an example computing apparatus as a functional block diagram.

FIG. 8 illustrates an exemplary gRPC environment implementing an aspect of the disclosure.

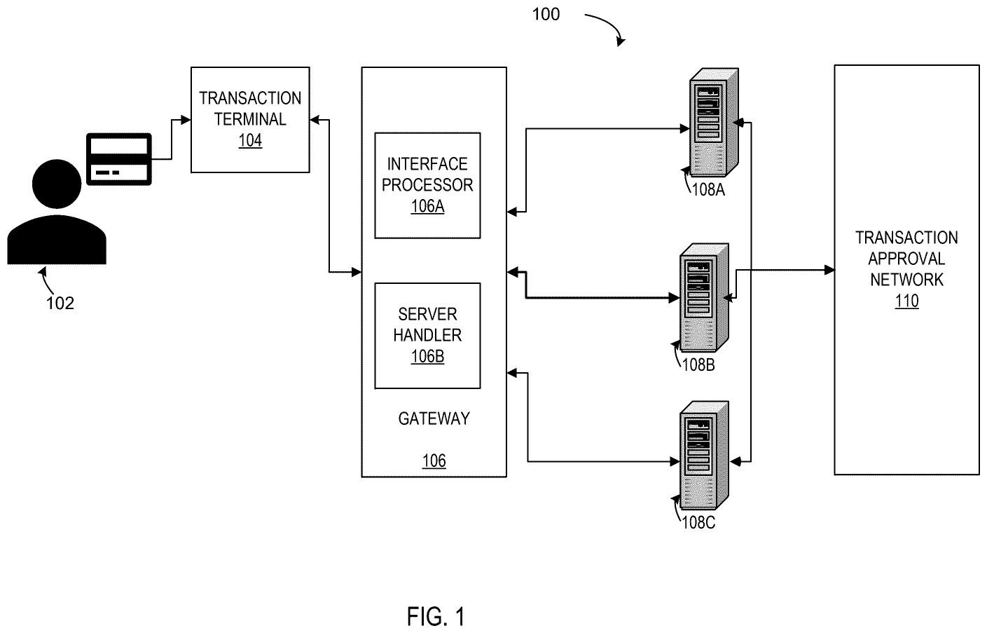

Corresponding reference characters indicate corresponding parts throughout the drawings. In FIGS. 1 to 8, the systems are illustrated as schematic drawings. The drawings may not be to scale. Any of the figures may be combined into a single example or embodiment.

### DETAILED DESCRIPTION

Aspects of the disclosure provide an improved computer system architecture and enhanced algorithmic approach for resource management, along with novel data processing methodologies to achieve reliable, low-latency transaction processing at scale. For example, aspects of the disclosure provide a system and a method for adaptive request handling in a real-time payment system using a remote procedure call (RPC) bidirectional stream mechanism through the introduction of an advanced server health score calculation system. Aspects of the disclosure provide adaptive handling of a transaction request based on real-time health assessment (e.g., workloads, etc.) including dynamically evaluating the server's health based on key parameters such as the last server response timestamp, the last known health status, server heartbeat, and the number of client request strikes since the last server response. By incorporating these factors into a comprehensive health score formula, the responsiveness and overall health of a server are continuously assessed, allowing for adaptive adjustments in request handling strategies.

Example technical problems addressed by the technical solutions provided in aspects of the disclosure include, but are not limited to, dynamic workloads, latency sensitivity, fault tolerance, client-server communication challenges, regulatory compliance, and resource optimization. These are next described.

Real-time payment systems often experience fluctuating and dynamic workloads, with varying levels of transaction requests at different times. Aspects of the disclosure provide a system that adapts to varying server loads, for example to handle dynamically changing workloads efficiently and/or ensure optimal performance even during peak transaction periods.

Real-time payment transactions require low latency to meet user expectations and regulatory requirements. Recognizing the critical importance of minimizing latency in real-time payment processing, aspects of the disclosure continuously assess and adapt the server's responsiveness to ensure timely transaction processing.

Unforeseen issues, such as network disruptions or hardware failures, can impact the availability and reliability of servers in a real-time payment system. Aspects of the disclosure address the need for a fault-tolerant system by dynamically assessing the server's health based on various parameters, allowing for adaptive response strategies when potential issues are detected.

Real-time payment systems involve bidirectional communication between clients and servers, making it essential to monitor and address communication challenges promptly. Aspects of the disclosure consider the number of client request strikes since the last server response, providing insights into potential communication issues and facilitating adaptive handling to maintain seamless client-server interactions.

Real-time payment systems often operate in highly regulated environments with stringent compliance requirements. Recognizing the importance of maintaining a consistent and auditable level of service in adherence to regulatory standards, aspects of the disclosure provide a system that ensures server health and responsiveness are continuously monitored.

Efficient resource utilization is crucial for cost-effectiveness and optimal performance in real-time payment systems. Aspects of the disclosure optimize resource allocation by dynamically adjusting request handling strategies based on the calculated server health score, ensuring that resources are allocated effectively to meet varying demands.

Aspects of the disclosure operate in an unconventional manner at least by performing a dynamic server health score calculation, and adapting request handling (e.g., in RPC bidirectional streams) using the dynamic server health score. For example, by adapting request handling based on the real-time health assessment, aspects of the disclosure provide improved reliability and responsiveness, a critical factor in real-time payment systems where transactions must be processed swiftly. In some examples, aspects of the disclosure provide adaptive response strategies based on the calculated health score, which provides an advantage over conventional systems (e.g., without such dynamic adaptation mechanisms, it is a struggle to optimize performance during fluctuating workloads, leading to potential delays and service disruptions, etc.). The dynamic nature of the health scoring system of aspects of the disclosure allows for effective resource optimization and/or utilization. For example, in a market where efficient resource utilization is crucial for cost-effectiveness, aspects of the disclosure provide a competitive edge by dynamically adjusting resource allocation based on the continuously evolving server health. The proactive approach (e.g., based on the number of client request strikes and last known health status, etc.) of aspects of the disclosure allows for proactive identification and mitigation of potential issues, which for example enhances fault tolerance and issue mitigation (e.g., minimizes the impact of unforeseen challenges, etc.).

Some aspects of the disclosure address technical challenges specific to the domain of the real-time payment market, for example providing improved reliability, responsiveness, and overall efficiency in the processing of real-time transactions. In particular, aspects of the disclosure ensure best available resource utilization for swiftly processing a payment transaction request in real time.

The disclosure operates in an unconventional manner to manage computing resources, for example by improving management of computing resources, improving the functioning of an underlying device, improving the technology real-time payment transaction processing, efficient utilization of the computing resources, and/or the like.

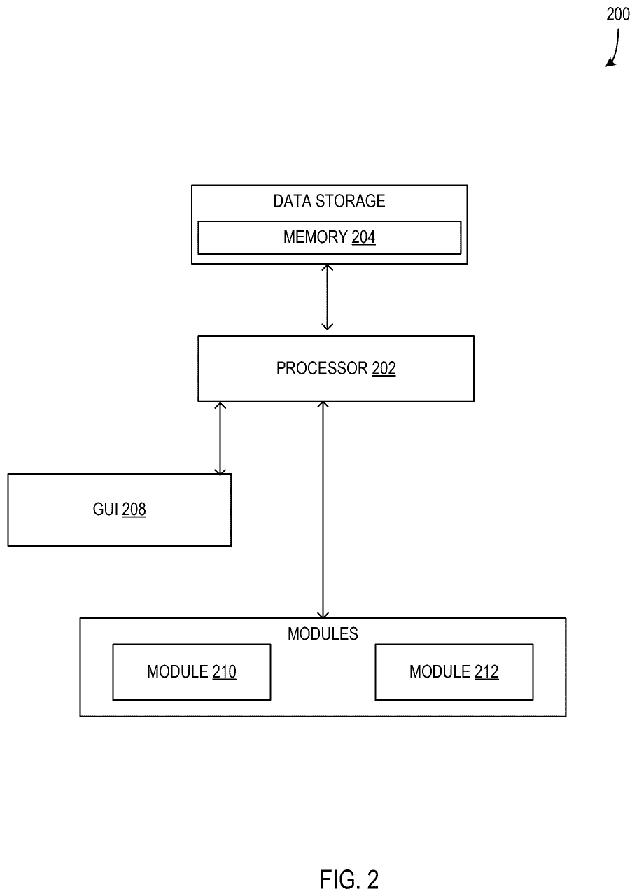

FIG. 1 is a block diagram illustrating a system 100 configured for adaptive request handling in real-time transactions. The system 100 comprises a user with a payment modality 102 (e.g. a credit card, a debit card, unified payment interface (UPI) on a user device) to initiate a transaction request. The system 100 also comprises a transaction terminal 104 which may be interfaced with the payment modality 102. The payment modality 102 may be issued by an issuer in collaboration with an acquirer. In some examples, the acquirer may be a bank and the issuer may be a card association. On receiving a user input via the payment modality 102 on the transaction terminal 104, the transaction request may be initiated (typically at client end). The client may be the acquirer (e.g. bank) or any entity associated with the bank which provides the transaction terminal to a merchant. The merchant receives the proceeds of the transaction in an account with the acquirer. The acquirer may be the owner of the transaction terminal provided to the merchant. The acquirer may be online or offline (physical). In the case of the online acquirer, the transaction terminal may be virtually provided on a user interface of a user device through a website/mobile application and the like for inputting the payment modality 102 details. The transaction request from the transaction terminal 104 may be directed to a gateway 106 which may include an interface processor 106A and a server handler 106B. The components of the gateway 106 may include integrated networking nodes or may be available as distributed networking nodes. The transaction request received from the transaction terminal 104 at the gateway 106 may need to be processed by the servers. One of the plurality of servers 108A, 108B, 108C may be used to process the transaction request. The server handler 106B at the gateway 106 may be configured to compute a health score of each of the plurality of servers 108A, 108B, 108C. The computation of the health score may be computed by an apparatus associated with the gateway 106 (e.g. the server handler 106B). The apparatus is further described in detail below referenced by the apparatus of FIG. 2. The gateway 106 through the server handler 106B is configured to select one of the servers 108A, 108B, 108C for processing the transaction request. The processing of the transaction may require approval using a number of nodes associated with the acquirer and the issuer of the credit card/debit card etc., and may be performed by the transaction approval network 110. The transaction approval network 110 may be associated with the number of nodes belonging to the issuer and the acquirer to complete the necessary approvals of the transaction request.

In some examples, the server handler 106B selects a Transmission Control Protocol (TCP) connection from a TCP connection factory associated with the gateway 106 to service the transaction request received from the transaction terminal 104. An event may be created on the server handler 106B for servicing the transaction request. The server handler 106B based on the transaction request may configure messages including port configuration, TCP connection tracker, TCP connection ID, identity of the acquirer and the user associated with the transaction request (based on the payment modality used by the user). The messages are provided in networking packets to one of the servers 108A, 108B, 108C for processing. The messages associated with the transaction request using the TCP connection are sent to server 108A, for example. The server along with the transaction approval network 110 may decode the messages and approve/reject the transaction request.

FIG. 2 is a block diagram illustrating an apparatus 200 configured for adaptive request handling in a real-time payment system. In some examples, the apparatus 200 of FIG. 2 is configured to operate in association with a system such as system 100 of FIG. 1.

In some examples, the apparatus 200 includes a processor 202 and a memory 204 configured to store computer program code. The memory 204 and the computer program code are configured to, with the processor 202, cause the processor 202 to perform various operations, functions, and/or the like of the apparatus 200 (e.g., the various operations, functions, and/or the like described and/or illustrated herein, etc.). In some examples, one or more operations, functions, results, conclusions, calculations, determinations, detections, and/or the like of the system 200 (e.g., the various operations, functions, results, conclusions, calculations, determinations, detections, and/or the like described and/or illustrated herein, etc.) may be provided for display via a graphical user interface (GUI) (e.g., as described and/or illustrated herein; a GUI 208 of the apparatus 200; a GUI of another apparatus, computing device, electronic device, server, and/or the like; etc.) and/or used for other purposes. The apparatus 200 may include one or more modules (e.g., the modules 210 and 212, etc.) for performing various functions, operations, and/or the like of the system 100. In some examples, the apparatus 200 may be an exemplary device performing the functions of the gateway 106 as shown in FIG. 1. In some examples, the apparatus 200 is an exemplary networking node performing the functions of the server handler 106B as shown in FIG. 1. In some examples, the gateway 106 shown in FIG. 1 functions as the apparatus 200 of FIG. 2.

In some examples, aspects of the disclosure use HTTP 2 TCP based protocol built on top of a generic remote procedure call (gRPC) framework. A request is sent over to a network from the gateway 106. In some examples, the gateway 106 is configured with the gRPC framework with bidirectional stream. The server gets the request, processes it, and sends it to a switching service and then further to a relevant issuer who issues a decision on the authorization request (e.g., approved, not approved, etc.). In some examples, the switching service and the issuer are part of the transaction approval network 110 of FIG. 1. Eventually, the request comes back through the same channel and then to the same TCP channel, The decision made by the issuer in the transaction approval network 110 is relayed back to the acquirer through the channel and the TCP channel, and then the acquirer sends it to the merchant.

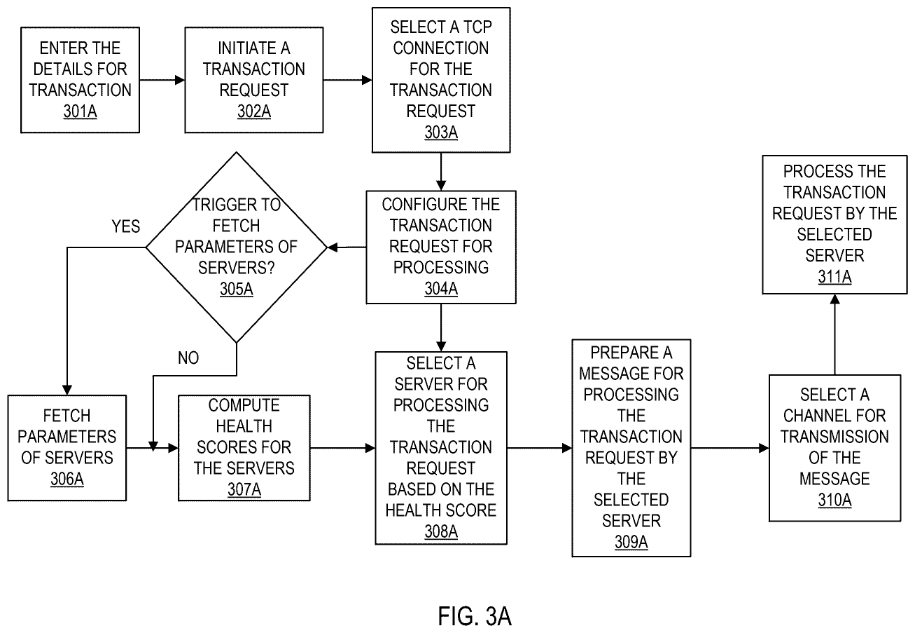

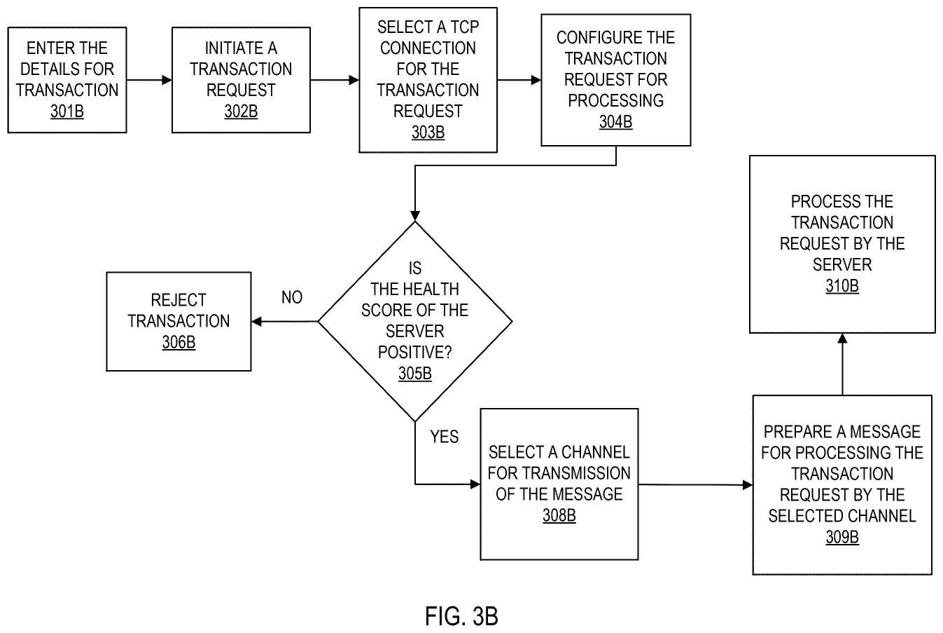

FIG. 3A illustrates an example of a flowchart of various exemplary operations, functions, and/or the like of the adaptive request handling in a real-time payment system of the disclosure. In some examples, the method of FIG. 3A is executed or otherwise performed in association with a system such as system 100 of FIG. 1 and the apparatus 200 of FIG. 2.

At operation 301A of the flowchart, details related to the transaction request are entered. In some examples, the credit card/debit card/QR code is input to the transaction terminal 104 for initiating a transaction request. The transaction terminal 104 may also prompt to enter credentials to initiate the transaction request.

At operation 302A of the flowchart, the transaction request is initiated and received by a gateway 106 or any network node for processing. In some examples, the gateway 106 is configured to select a TCP connection for sending the transaction request. The gateway may also be configured to monitor a health status of the one or more servers 108A, 108B, 108C. At operation 303A, a TCP connection for the transaction request is selected from a factory of the TCP connections by the gateway 106. In some examples, the TCP connection factory is available on a separate network node or may be available within the gateway 106.

At operation 304A of the flowchart, the transaction request may be configured for processing using the TCP connection selected in operation 303A. At operation 304A of the flowchart, an event is created including an identity of the acquirer, issuer, user and/or the like. A connection port for making a connection with the server using the TCP connection may be established for transmitting the transaction request in the form of messages. The messages include details of the transaction request and different identifiers required for authenticating the transaction request by the server 108A, 108B, 108C. The messages are configured for transmission on a channel based on the selected TCP connection.

At operation 305A of the flowchart, a trigger to fetch one or more parameters of the servers is initiated. The one or more parameters may be used to determine a health score of each of the servers. Some examples of the adaptive request handling in a real-time payment system operate through a system that continuously assesses and adapts the server's responsiveness based on the parameters. Examples of the parameters are next described.

The parameters include, but are not limited to, a last server response timestamp, which represents the time elapsed since the server's last response. The variable sTLR represents a time since last response from the server—the time factor (e.g., current_timestampserver_last_response_timestamp)

The parameters include, but are not limited to, a last known health status, which represents the server's health status, distinguishing between healthy and unhealthy states. The variable sLH below represents a last known server health status (e.g., last_known_health_status=SERVING).

The parameters include, but are not limited to, a server heartbeat, which represents the regularity and consistency of the server's heartbeat. A variable sHB below represents the heartbeat score (e.g., server heartbeat interval & status). In RPC, this can be implemented using a health check protocol.

The parameters include, but are not limited to, a number of client request strikes, which represents the count of client request strikes since the last server response. The variable tSR provided below represents the total request strike since the last server response (e.g., client's request strikes since last_server_response_time). The tSR variable quantifies the impact of the number of client request strikes since the last server response, providing insights into communication challenges.

The different other parameters are described below but not limited to these parameters:
sRT represents a server response time threshold
mRT represents a max request strike threshold

Metrics of each of the one or more parameters are determined for each of a plurality of servers associated with the gateway 106. In some examples, metrics for all the parameters described above are determined.

The gateway 106 employs a mathematical formula to calculate the server health score dynamically. Example equations (1), (2), (3), (4) shown below calculate a number of factors sAT(x), cRS(x), sHS(x), sHB(x), but aspects of the disclosure are not limited to these factors. The factors/variables are calculated based on the parameters as described below:

$$sAT ( x ) = {\int }_{0}^{n} α * ( \frac{( sRT ) - sTLR ( x )}{sRT} ) \qquad ( 1 )$$

$$cRS ( x ) = {\int }_{0}^{n} β * ( \frac{mRT - tSR ( x )}{mRT} ) \qquad ( 2 )$$

$$sHS ( x ) = {\int }_{0}^{n} ( Υ * sLH ( x ) ) \qquad ( 3 )$$

In some examples, the health score is computed based on an equation (4) as shown below.

$$Health Score ( x ) = {\int }_{0}^{n} hSS ( x ) = \sum \frac{sAT ( x ) + cRS ( x ) + sLHS ( x ) + ( λ * sHB ( x ) )}{4} \qquad ( 4 )$$

In the above equations (1)-(4), n represents a final time relative to initial time for which the factor/variable/health score is computed. α (alpha), β (beta), γ (gamma), and λ (delta) are weight factors assigned to each parameter, allowing for fine-tuning the influence of each factor on the overall health score. In some examples, recent historical data is used to adjust weights factors dynamically. As an example, if request strikes (cRS(x)) are the most common cause of degraded performance, β is increased dynamically. As another example, if the heartbeat delays (sHS(x)) are noisy, γ is reduced dynamically.

The factors are calculated using the one or more parameters described above.

The factors are described next:
sAT represents a server alive time score, the sAT variable evaluates the impact of the time elapsed since the last server response, a higher value indicates a longer time gap, potentially affecting server responsiveness.
cRS represents a calculated request strike score
sHS represents a server health status score, the sHS variable considers the last known health status, assigning a weight to differentiate between healthy and unhealthy states
sHB represents a server heartbeat score (e.g., server heartbeat interval & status), in RPC this can be implemented using a health check protocol, the sHB variable incorporates the server heartbeat interval, with a lower interval receiving a higher factor, reflecting a more consistently beating “heart” of the server. In some examples, the server heartbeat is a form of a remote procedure call. In some examples, the heartbeat of the server may be a number of remote procedure calls handled by the server in a predefined interval of time.

The health score of the server is computed using the factors described above and represented as hSS.
hSS represents server health score, in some examples a server is considered “healthy” if sAT, cRS, sHS (and/or sLHS), and sHB are within a threshold (e.g., the equation returns a positive number, etc.). In some examples, a server is considered “unhealthy” if sAT, cRS, sHS (and/or sLHS), and/or sHB are not within threshold (e.g., the formula returns a negative number, etc.).
α weight factor for sAT (server alive time score),
β weight factor for cRS (calculated request strike score),
γ weight factor for sHS (server health status score), and
λ weight factor for sHB (server heartbeat score).

In some examples, the weight factors may be associated with an order of relevance. As an example, the order of relevance may be α, γ, λ, β. Any other order of relevance of the weight factors is also within the scope of the disclosure. In some examples, the order of relevance of the weight factors lets the apparatus (e.g. gateway 106) react proportionally and intelligently to different kinds of failures or performance degradations. In some examples, time to process the transactions (latency (T)) starts increasing, the health score of the server would reduce greatly due to latency factor because payment systems are latency-sensitive, and long response times likely indicate resource pressure or queuing delays. If the number of request strikes are increasing, the system should also react, but perhaps a bit more patiently—since retries could be client-side jitter and accordingly of lesser relance than latency. If health probe status (S) turns NOT_SERVING, the score drops even if other factors are working fine and is of lesser relevance than latency and request strikes. Heartbeat jitter (H) is least critical unless it persists—so its weight is lowest.

The calculated health score provides a real-time assessment of the server's health and responsiveness. Threshold conditions may be established to trigger specific actions based on the calculated health score. For example, if the health score falls below a certain threshold, adaptive response strategies are initiated, such as adjusting request handling mechanisms or notifying administrators. Accordingly, based on the health score, dynamic adaptation to the transaction request may be achieved.

The equation (4) used to calculate the server health score (hSS) may be stated as calculating weighted scores for a server alive time parameter, a request strike parameter, a server health status parameter, and a server heartbeat parameter; and averaging and summating a last known server health status parameter and the weighted scores of the server alive time parameter, the request strike parameter, and the server heartbeat parameter. In some examples, the last known server health status parameter is based on the weighted score of the server health status parameter. The last known server health status is a snapshot of the server's state, typically reported by an internal health check (e.g., gRPC's Health Service API returning SERVING, NOT_SERVING, etc.). Rather than treating this health status as an absolute on/off switch, the adaptive system assigns it a weighted influence—like a confidence signal—on the total health score. As an example, a server is showing normal response times and low memory usage. However, its internal health probe reports a NOT_SERVING status—perhaps because of a failing dependency or a backend issue. If the system assigns a moderate-to-high weight to this health status parameter, the total health score will decrease significantly, signaling that the server is no longer safe to route traffic to—even though performance appears fine on the surface.

Conversely, if health status is set to SERVING but all other signs (like high retries and slow responses) indicate trouble, and the weight of health status is low, then the system would not overly rely on this signal alone. It will make a more balanced, data-driven decision by factoring in more volatile or real-time signals.

An example of is now provided with a progression from a healthy server state to an unhealthy server state which is characterized by a deteriorating health score (hSS). Initially, a server may be deemed healthy, as indicated by a health score (hSS) of the server 0.1844, 0.2066 and so on indicative of a progressively improving health score. As described above, the health score of the server is based upon server responses time (sRT), request strikes (cRS), server health status (sHS). However, the server's health deteriorates and the health score of the server is −0.18474 and deemed an unhealthy server. The client request strikes are increasing and the server health status is “NOT_SERVING”. The server alive time (sAT) decreases indicating potential issues with the server. On further probing of the server, the health score (hSS) of the server is now changed to −0.2854375 and the client request strikes (cRS) are increasing, the server health status is NOT_SERVING and the sAT decreases further. Thus, a change of the health score of the server indicates whether or not the server is reliable to process the transaction requests.

In some examples, one or more weights are calculated empirically, hardcoded, include arithmetic numbers, and/or the like. In some examples, one or more weights is determined using artificial intelligence (AI) which may be based on the previous transaction requests assessment.

Referring back to operation 305A of the flowchart, the one or more parameters as described above are fetched at operation 306A and health score (hSS) of each server is computed at operation 307A as discussed above. Based on the computed health score, a server is selected for processing the transaction request at operation 308A of the flowchart.

If the trigger at 305A is “No” in case one or more parameters are already available with the gateway 106, the health score of each server is computed, then the server is selected directly for processing the transaction at operation 308A. In some examples, if the parameters are present and the health score is already computed, the process may directly select the server for processing the transaction request at operation 308A.

At operation 309A of the flowchart, a message with the TCP connection may be prepared for transmission to the selected server. At operation 310A of the flowchart, a channel is selected for transmission of the message to the selected server.

At operation 311A of the flowchart, the transaction request in the message may be processed and may be approved/rejected by the transaction approval network 110 as discussed above. The result of the processing of the transaction request may be provided back through the same channel to the gateway 106 and back to the transaction terminal 104.

FIG. 3B illustrates an example of a flowchart of various exemplary operations, functions, and/or the like of the adaptive request handling in a real-time payment system of the disclosure using a single server for processing the transaction request. In some examples, the method of FIG. 3B is executed or otherwise performed in association with a system such as system 100 of FIG. 1 and the system 200 of FIG. 2 and method performed in the flowchart of FIG. 3A.

At operation 301B of the flowchart, details related to the transaction request are entered as discussed in FIG. 3A.

At operation 302B of the flowchart, the transaction request is initiated and received by a gateway or any network node 106 for processing. The gateway may also be configured to monitor a health status of the one or more servers 108A, 108B, 108C. At operation 303B, a TCP connection for the transaction request is selected from a factory of the TCP connections by the gateway 106 as described in FIG. 3A.

At operation 304B of the flowchart, the transaction request is configured for processing using the TCP connection selected in operation 303B. At operation 304B of the flowchart, an event is created and messages including identity of the acquirer, issuer, user and/or the like are identified and made part of the messages. A connection port for making a connection with the server using the TCP connection is established. The messages include details of the transaction request and different identifiers required for authenticating the transaction request by the server 108A, 108B, 108C.

At operation 305B of the flowchart, it is determined whether a health score of the server is positive. If the health score needs to be computed, the health score is computed using parameters which are prefetched and available with the gateway 106.

If it is determined that the health score is positive, a channel is selected to transmit a message with the transaction request at operation 308B of the flowchart. If the health score is not positive, the transaction request is rejected at 306B. In some examples, an alternative channel for the server is identified for processing of the transaction request.

At operation 309B of the flowchart, a message for processing of the transaction request is prepared using the selected channel for transmission to the server. The transaction request is subsequently processed using the server, at operation 310B, as discussed with reference to FIG. 3A. The transaction approval network 110 is involved to process the transaction request after processing by the server.

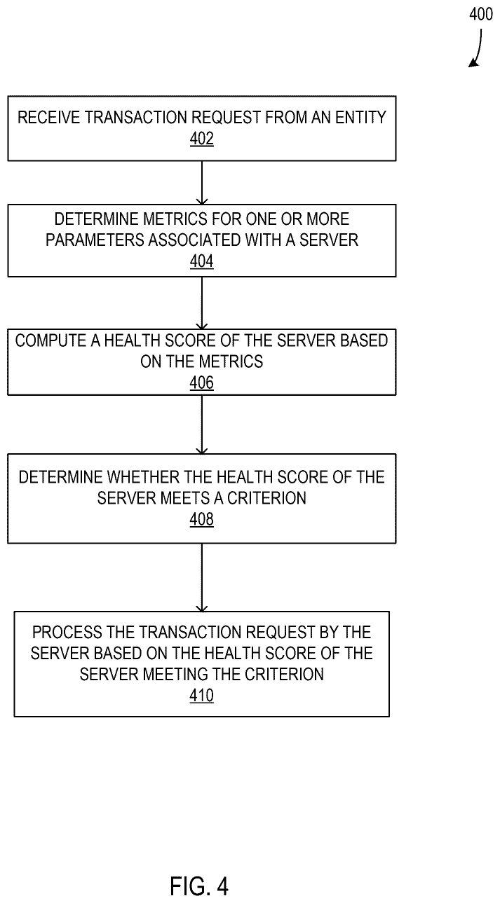

FIG. 4 illustrates an example of a flowchart of various exemplary operations, functions, and/or the like of the adaptive request handling in a real-time payment system for processing the transaction request. In some examples, the method of FIG. 4 is executed or otherwise performed in association with a system such as system 100 of FIG. 1, the system 200 of FIG. 2, and method performed in the flowchart of FIG. 3A and FIG. 3B.

The flow chart 400 starts at operation 402. At operation 402, a transaction request is received from an entity. The entity may be a transaction terminal 104 of FIG. 1 or any other node associated with the transaction terminal 104.

At operation 404 of the flowchart, metrics for one or more parameters may be determined as discussed above. In some examples, metrics include time elapsed since the server's last response. In some examples, the metrics include a last known server health status (e.g., last_known_health_status=SERVING). In some examples, metrics include a heartbeat score (e.g., server heartbeat interval & status). In some examples, metrics include a number of client request strikes, which represents the count of client request strikes since the last server response.

At operation 406 of the flowchart, a health score (hSS) is computed based on the metrics associated with the parameters as discussed above.

At operation 408 of the flowchart, it is determined whether the health score of the server meets a criterion. The criterion is associated with the health score being positive or negative. If the health score is positive, the transaction request is processed. In case, the health score may be negative, alternative strategies are used to process the transaction request. Alternatively, the criterion is associated with a threshold score. If the health score is above a threshold, the criterion is met. In case the health score is below a threshold, the criterion is not met. In some examples, the criterion is associated with rate of change in health score with each probe. If with each probe the health score is reduced towards the threshold, then the criterion may not be satisfied. If with each probe the rate of change of the health score is positive with respect to the threshold, then the criterion may be met. The probe may be periodically sent through a channel to the server by the gateway to determine the parameters and the health score may be computed.

At operation 410 of the flowchart, the transaction request is processed based on the health score meeting the criterion. The criterion is associated with a positive or negative health score as discussed above.

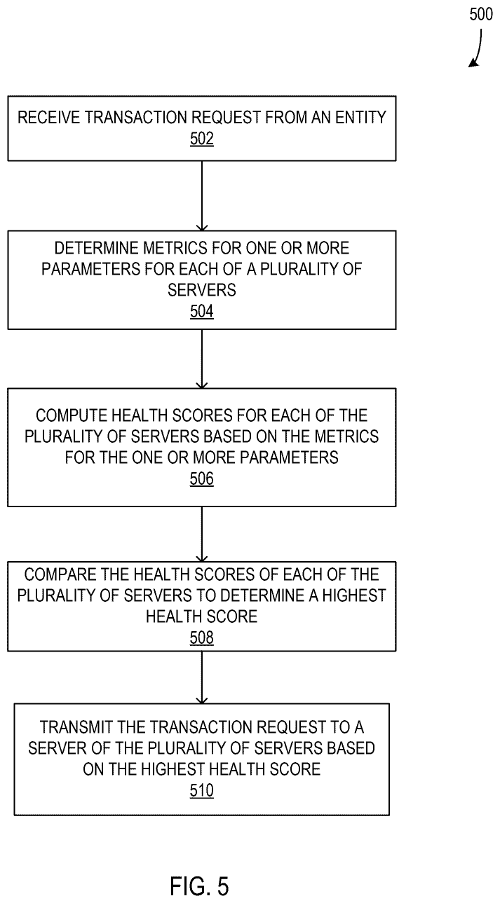

FIG. 5 illustrates an example of a flowchart of various exemplary operations, functions, and/or the like of the adaptive request handling in a real-time payment system for processing the transaction request. In some examples, the method of FIG. 5 is executed or otherwise performed in association with a system such as system 100 of FIG. 1, the system 200 of FIG. 2, and method performed in the flowchart of FIG. 3A, FIG. 3B, and FIG. 4.

The flow chart 500 starts at operation 502. At operation 502, a transaction request is received from an entity. In some examples, the entity is a transaction terminal 104 of FIG. 1 or any other node associated with the transaction terminal 104.

At operation 504 of the flowchart, metrics for one or more parameters are determined for each of a plurality of servers associated with the gateway 106. In some examples, metrics include time elapsed since the server's last response. In some examples, the metrics include a last known server health status (e.g., last_known_health_status=SERVING). In some examples, metrics include a heartbeat score (e.g., server heartbeat interval & status). In some examples, metrics include a number of client request strikes, which represents the count of client request strikes since the last server response. The metrics for the parameters are collected from each of the plurality of servers to compute health score for each of the plurality of servers. The metrics of the one or more parameters are already discussed above.

At operation 506 of the flowchart, a health score (hSS) is computed based on the metrics associated with the parameters for each of the plurality of the servers as discussed above.

At operation 508 of the flowchart, the health scores of the servers are compared and a highest health score is determined. In addition, the criterion as discussed above in FIG. 4 may be applied as a condition to process the transaction request.

At operation 510 of the flowchart, the transaction request is transmitted to a server from the plurality of servers based on the highest health score. The server associated with the highest health score in the operation 508 is selected for processing the transaction request.

Aspects of the disclosure provides adaptability in processing the transaction request in real-time payment systems. Such adaptability avoids or reduces latency in processing the transaction request and in server downtime. Thus, the aspects of the disclosure provides a fail-safe mechanism in processing of the transaction requests, particularly in real time payments.

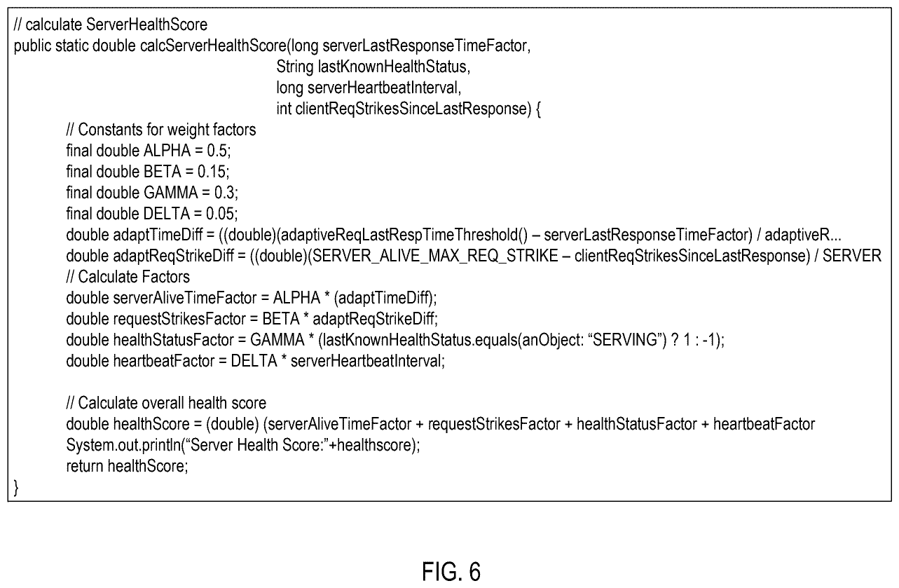

FIG. 6 illustrates a run-time example of an aspect of the disclosure. The run-time example illustrates calculation of a server health score using the parameters as described herein. The example also illustrates weight factors α (alpha), β (beta), γ (gamma), and λ (delta) being defined for computing the server health score. Each of the factors including a server alive time score, a request strike score, a server health status score, and a server heartbeat score is calculated. Finally, an overall server health score is computed with the weighted factors.

In some examples, the server health scores (hSS) may be used in a variety of ways, methods, manners, and/or the like to provide the adaptive request handling in a real-time payment system of the disclosure. For example, the server health scores of two or more servers can be compared, and the server with the highest score (e.g., the “healthiest” server, etc.) is selected to process a requested transaction. For example, the system 100 receives a transaction request from an entity, calculates a server health score for at least two servers, and compares the calculated server health scores to determine the server with the highest server health store. The server with the highest health score is then selected to process the transaction request.

In some examples, as an alternative, instead of a single formula, the method is conditional (e.g., if a first score is above a threshold, then check a second score, etc.) In this example, each of the scores sAT, cRS, sHS, and sHB are calculated in a sequence based on whether or not the previous score in the sequence meets (e.g., satisfies, etc.) a condition and/or one or more criteria (e.g., a threshold, etc.), and the status of the server being healthy or unhealthy is determined. Accordingly, the computation of all the factors required to check whether the server is healthy or unhealthy, and the health check of the server is expedited.

In some examples, aspects of the disclosure enable acquirers and other clients (e.g., merchants, etc.) to interface with the network and to transact (e.g., authentication, authorization, refund, other degrees of transactions. In some examples, aspects of the disclosure provide and/or operate with a dual messaging system whereby when an authorization request for a transaction is submitted by a merchant on behalf of a customer, it gets routed to an acquirer of the merchant (e.g., to the system 100, etc.).

In some examples, aspects of the disclosure provide an equation-based adaptive health check service that facilitates alerts before an issue occurs (e.g., based on thresholds, criteria, conditions, etc.). In some examples, aspects of the disclosure include sending health probes (e.g., sent by the system 100, sent by another device, received by a server, etc.) to learn the health status of a server. The server responds to the health probe with a health status (e.g., serving, not serving, unknown, etc.). In some examples, the health probe includes a deadline, a timeout, and/or the like (e.g., 500 milliseconds, etc.), which may include network latency (e.g., based on transmission distance, etc.). In some examples, a server voluntarily sends a health status (e.g., without receiving a health probe, etc.).

In some examples, the health score formula (e.g., hSS, etc.) is applied to each server in a pool of n servers wherein the weighted scores sAT, cRS, sHS, and sHB are averaged and added up to be a cumulative number. In some examples, aspects of the disclosure iteratively go through each of the n servers and calculate the server health scores and keep them in the pool (e.g., for any given request, the system 100 checks if server 1 is healthy, then if server 2 is healthy, then if server 3 is healthy, and so on so it is known based on these calculations what are the servers that the request can be sent to). In some examples, a negative server health score prevents a server from being used to process a transaction request. For example, in response to a server having a negative server health score, the system 100 selects another server from the pool of servers and evaluates whether the other server is healthy or not using the server health score of the other server. If no servers are healthy, the request, in some examples, is processed by the transaction terminal 104 (e.g., a merchant device and/or appliance, a device and/or appliance at the merchant, etc.) itself (e.g., with logic of the system 100 built into the device, etc.). In some examples, aspects of the disclosure enable devices to know whether to do authorization on behalf of the network, whether to send the authorization, or whether to do a retry. In some examples, aspects of the disclosure provide multiple levels of resiliency built-in and/or help devices with resiliency factors. In some examples, aspects of the disclosure provide load balancing, for example to distribute a request equally among healthy servers.

In some examples, various combinations and sub-combinations may be contemplated. In some aspects of the disclosure, a transaction request from an entity is received by a system (e.g. gateway 106). Metrics for the one or more parameters are determined. The one or more parameters may comprise a last server response timestamp, last known server health status, server heartbeat, and a total request strike since last server response. A health score of the server is computed by calculating weighted scores for a plurality of factors such as a server alive time parameter, a request strike parameter, a server health status parameter, and a server heartbeat parameter. In some examples, the health score of the server is computed by averaging and summating the weighted scores of the plurality of factors. It is determined whether the health score of the server meets a criterion and the transaction request is processed by the server based on the health score of the server meeting the criterion.

In some examples, the criterion comprises determining a rate of change of the health score of the server. If the rate of change of the health score proceeds towards negative, the server may not be used for processing the transaction request. On the other hand, if the rate of change of the health score increases and becomes a more positive value, the server is likely be used for processing the transaction request.

In some examples, the weighted scores of the plurality of factors comprise calculating the server alive time score based on a server response time threshold and a last response timestamp, calculating the request strike score based on a maximum request strike threshold and a total request strike since last server response, and calculating the server health status score based on last known server health status.

In some examples, determining that the health score of the server meets the criterion comprises determining that the health score of the server is positive. Alternatively, in some other examples, determining that the health score of the server meets the criterion comprises determining that the health score of the server is equal to and/or above a threshold.

In some examples, a probe is sent to each of the servers for determining metrics for each of the one or more parameters periodically. In some examples, the probe is sent over a channel for determining the metrics for each of the one or more parameters, and metrics are received over the same channel.

In some examples, determining whether the health score of the server meets the criterion comprises calculating a server heartbeat score at a location physically remote from the server. The health score may be determined by a network node (e.g. gateway 106) which is physically remote to the server 108A, 108B, 108C. The heartbeat of the plurality of servers is monitored using a periodic signal transmitted to each of the plurality of servers.

In some examples, various combinations and sub-combinations may be contemplated. In some aspects of the disclosure a transaction request from an entity and metrics for one or more parameters for each of a first server and a second server are determined. A first health score of the first server is computed based on the metrics of the first server and a second health score is computed based on the metrics of the second server. In some examples, the first health score and the second health score is computed by calculating weighted scores of a plurality of factors based on the one or more parameters, and by averaging and summating the weighted scores of the plurality of factors. The first health score and the second health score are compared to determine a higher health score and the transaction request is sent to the first server or the second server based on the higher health score.

In some examples, the server heartbeat score is a number of remote procedure calls handled by the server in a predefined interval of time.

In some examples, various combinations and sub-combinations may be contemplated. In some aspects of the disclosure a transaction request from an entity and metrics for one or more parameters for each of a plurality of servers are determined. Health score of each of the plurality of servers are computed based on the metrics of the one or more parameters. The health score for each of the plurality of servers is computed by calculating weighted scores of a plurality of factors based on the one or more parameters, and by averaging and summating the weighted scores of the plurality of factors. The health scores of each of the plurality of servers are compared to determine a highest health score and the transaction request is transmitted for processing to a server of the plurality of servers based on the highest health score.

In some examples, a probe is sent to each of the plurality of servers for determining metrics for each of the one or more parameters for the plurality of servers. The probe is sent over a channel to the plurality of servers for determining the metrics for each of the one or more parameters and receiving the metrics over the same channel.

In some examples, a heartbeat of the plurality of servers is monitored using a periodic signal transmitted to each of the plurality of servers.

In some examples, determining the health scores of the plurality of servers comprise calculating weighted scores for a plurality of factors using one or more parameters for each of the plurality of servers and averaging and summating the weighted scores of the plurality of factors for each of the plurality of servers.

In some examples, a method includes receiving a payment request from merchant and performing a health check (e.g., on acquirer, etc.). Performing the health check includes determining (e.g., detecting, calculating, etc.) which server is healthy and/or is able to handle a particular transactions per request (TPS). The method includes sending the request to the healthy server (e.g., at the acquirer, but controlled by another party).

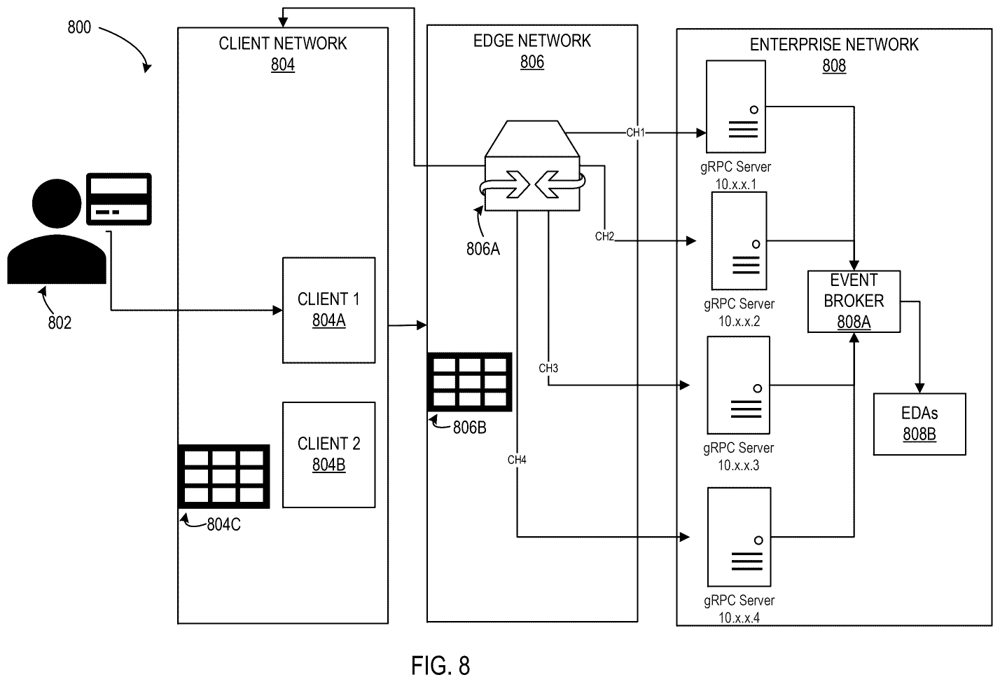

FIG. 8 illustrates an exemplary gRPC environment implementing an aspect of the disclosure. The gRPC environment 800 comprises a user 802 having transaction means such (e.g. a credit card, a debit card, unified payment interface on a device used by the user for payments) to initiate a transaction. The environment 800 comprises a client network 804 comprising a transaction terminal (e.g. transaction terminal 104 of FIG. 1) with client 1 804A, client 2 804B, etc. The client network may enable a graphical user interface (GUI) to display a health status 804C of the servers catering to the transaction requests for the clients. The environment also comprises an enhanced data rate GSM (EDGE) network 806. An edge network 806 is a type of cloud-based network designed to lower the load at the server and back-end devices by relocating many computing tasks away from servers and back-end devices. The transaction request from the client network 804 may be directed the edge network 806. The edge network comprises a gateway 806A in this example. In some examples, the gateway 806A is similar to the gateway 106 described in FIG. 1. The edge network 806 may include different components to process the transaction request by the servers. The gateway 806A may also comprise a server handler (for e.g. 106B of FIG. 1) which may be configured to compute a health score of each of the servers.

The gateway 806A may have channels representing virtual connections to an endpoint, which may be backed by many hyper-text transfer protocols, version 2 (HTTP/2) connections. The gRPC based connection uses HTTP/2 streams. Messages are associated with gRPCs and get sent as HTTP/2 data frames. The messages are layered on top of data frames. A data frame may have many gRPC messages. The gRPC messages include the transaction request as discussed above. In addition, the gateway also includes resolvers and load balancers. The resolver turns names of the servers into addresses of the servers and then hands these addresses to the load balancer. The load balancer is in charge of creating connections from these addresses and load balancing RPCs between connections. The gateway 806 computes a health score (e.g. by the server handler 106B of FIG. 1). In particular, the health status and the health score thereof may be stored by the gateway 806 and may also be displayed on GUI 806B. The health score may also be relayed to the client network 804. The computation of the health score is discussed herein and not repeated herein for sake of brevity. In some examples, the edge network 806 has the components configured for dynamic throttling using the health score. The health scores may be monitored and probed continuously at regular intervals or there may be event-based triggering. The clients may be dynamically throttled based on declining health scores (e.g., due to high memory or TCP retransmissions). In some examples, the clients are presented to use the servers in accordance with priority based on the health scores (e.g. from highest scores to lowest scores of the servers).

The gRPC environment 800 comprises an enterprise network 808 having servers with addresses to cater to the transactions request based on the gRPC based connections. The servers are represented by unique addresses and each of the servers may send the parameters for scoring by the gateway 806 in the edge network. The enterprise network may also include an event broker 808A which, in coordination with event driven architecture applications (EDAs), processes the transaction request being catered by any of the servers in the enterprise network 808. In some examples, the enterprise network 808 is similar to the transaction and approval network 110 as described in FIG. 1.

In some examples, the health score computed by the gateway and displayed therein is in the form of a table with the health status, health score, and the network address of each server. An exemplary health status displayed at the edge network 806 at 806B and the client network 804 at 804C is as follows:

TABLE 1

| gRPC Connection | | |
|---|---|---|
| (server address) | Health status | Health score |
| 10.x.x.1 | SERVING | 0.75 |
| 10.x.x.4 | SERVING | 0.65 |
| 10.x.x.3 | SERVING | 0.55 |
| 10.x.x.3 | NOT SERVING | −0.28 |

It can be seen in the exemplary Table 1 above, the health score is in the order of priority with the server having best health status provided at the top of the list. In some examples, the server with the best health status (10.x.x.1) is available for serving first followed by the second server with address (10.x.x.4). Similarly, the server with address 10.x.x.3 is the third server for catering to the transaction request. The server with address 10.x.x.3 has a negative health score of −0.28 and therefore is not available to serve any transaction requests. In some examples, the connections with the best health score are automatically configured to be used for serving the transaction requests by the client network 104.

In some examples, the health score is used to provide predictive circuit breakers. In some examples, regular monitoring of the health scores of each server indicates that the health score of a specific server is declining and accordingly the performance of the server is degrading. It may be predicted that a connection will degrade. The edge network 806 may preemptively break or shed load related to the specific server with degraded performance before full failure.

### Exemplary Operating Environment

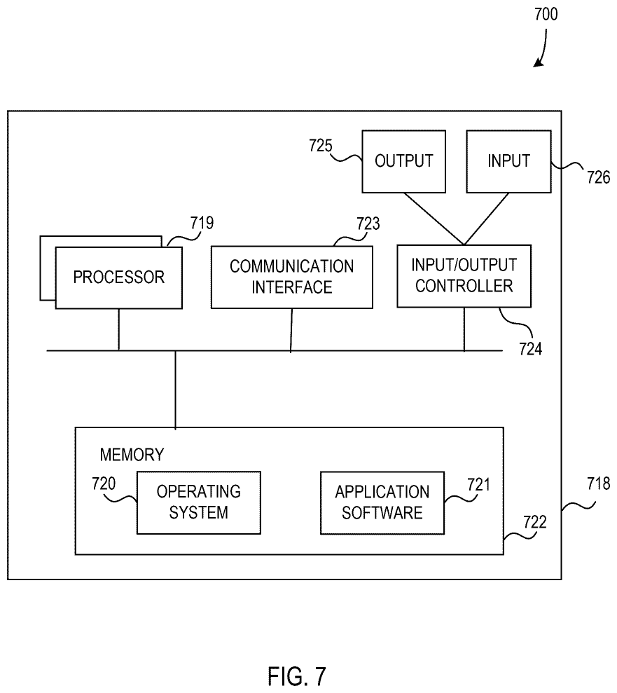

The present disclosure is operable with a computing apparatus according to an embodiment as a functional block diagram 700 in FIG. 7. In an example, components of a computing apparatus 718 are implemented as a part of an electronic device according to one or more embodiments described in this specification. The computing apparatus 718 comprises one or more processors 719 which may be microprocessors, controllers, or any other suitable type of processors for processing computer executable instructions to control the operation of the electronic device. Alternatively, or in addition, the processor 719 is any technology capable of executing logic or instructions, such as a hard-coded machine. In some examples, platform software comprising an operating system 720 or any other suitable platform software is provided on the apparatus 718 to enable application software 721 to be executed on the device.

In some examples, computer executable instructions are provided using any computer-readable media that is accessible by the computing apparatus 718. Computer-readable media include, for example, computer storage media such as a memory 722 and communications media. Computer storage media, such as a memory 722, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 722) is shown within the computing apparatus 718, it will be appreciated by a person skilled in the art, that, in some examples, the storage is distributed or located remotely and accessed via a network or other communication link (e.g., using a communication interface 723).

Further, in some examples, the computing apparatus 718 comprises an input/output controller 724 configured to output information to one or more output devices 725, for example a display (e.g., displaying a GUI, etc.) or a speaker, which are separate from or integral to the electronic device. Additionally, or alternatively, the input/output controller 724 is configured to receive and process an input from one or more input devices 726, for example, a keyboard, a microphone, or a touchpad. In one example, the output device 725 also acts as the input device. An example of such a device is a touch sensitive display. The input/output controller 724 may also output data to devices other than the output device, e.g., a locally connected printing device. In some examples, a user provides input to the input device(s) 726 and/or receives output from the output device(s) 725.

The functionality described herein can be performed, at least in part, by one or more hardware logic components. According to an embodiment, the computing apparatus 718 is configured by the program code when executed by the processor 719 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Any range or device value given herein may be extended or altered without losing the effect sought, as will be apparent to the skilled person.

Examples may have been described with reference to data monitored and/or collected from the users. In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements. Any of the functions, operations, and/or the like of the systems, methods, and the like disclosed herein are, in some examples, performed automatically by one or more processors, modules, AI engines, models, and/or the like.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation (e.g., different steps, etc.) is within the scope of aspects of the disclosure.

The term “comprising” is used in this specification to mean including the feature(s) or act(s) followed thereafter, without excluding the presence of one or more additional features or acts. The terms “comprising,” “including,” and “having” are intended to be inclusive and mean that there can be additional elements other than the listed elements. In other words, the use of “including,” “comprising,” “having,” “containing,” “involving,” and variations thereof, is meant to encompass the items listed thereafter and additional items. Accordingly, and for example, unless explicitly stated to the contrary, implementations “comprising” or “having” an element or a plurality of elements having a particular property can include additional elements not having that property. Further, references to “one implementation” or “an implementation” are not intended to be interpreted as excluding the existence of additional implementations that also incorporate the recited features. The term “exemplary” is intended to mean “an example of”.

When introducing elements of aspects of the application or the examples thereof, the articles “a,” “an,” “the,” and “said” are intended to mean that there are one or more of the elements. In other words, the indefinite articles “a”, “an”, “the”, and “said” as used in the specification and in the claims, unless clearly indicated to the contrary, should be understood to mean “at least one.” Accordingly, and for example, as used herein, an element or step recited in the singular and preceded by the word “a” or “an” should be understood as not necessarily excluding the plural of the elements or steps.

The phrase “one or more of the following: A, B, and C” means “at least one of A and/or at least one of B and/or at least one of C.” The phrase “and/or”, as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either,” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

It is to be understood that the above description is intended to be illustrative, and not restrictive. For example, the above-described implementations (and/or aspects thereof) can be used in combination with each other. In addition, many modifications can be made to adapt a particular situation or material to the teachings of the various implementations of the application without departing from their scope. While the dimensions and types of materials described herein are intended to define the parameters of the various implementations of the application, the implementations are by no means limiting and are example implementations. Many other implementations will be apparent to those of ordinary skill in the art upon reviewing the above description. The scope of the various implementations of the application should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various implementations of the application, including the best mode, and also to enable any person of ordinary skill in the art to practice the various implementations of the application, including making and using any devices or systems and performing any incorporated methods. The patentable scope of the various implementations of the application is defined by the claims, and can include other examples that occur to those persons of ordinary skill in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
a processor; and
a memory comprising computer program code, the memory and the computer program code configured to, with the processor, cause the processor to:
receive a transaction request from an entity;
determine metrics for one or more parameters associated with a server, wherein the one or more parameters comprise a last server response timestamp, a last known server health status, a server heartbeat, and a total request strike since last server response;
compute a health score of the server based on the metrics by calculating weighted scores of a plurality of factors based on the one or more parameters, wherein the health score is computed by averaging and summating the weighted scores of the plurality of factors, the plurality of factors comprising a server alive time score, a request strike score, a server health status score, and a server heartbeat score;
determine whether the health score of the server meets a criterion; and
process the transaction request by the server based on the health score of the server meeting the criterion.

2. The system of claim 1, wherein the scores of the plurality of factors are calculated based on the following expressions:
$$sAT ( x ) = {\int }_{0}^{n} α * ( \frac{( sRT ) - sTLR ( x )}{sRT} ) \\ cRS ( x ) = {\int }_{0}^{n} β * ( \frac{mRT - tSR}{mRT} ) \\ sHS ( x ) = {\int }_{0}^{n} ( Υ * sLH ( x ) )$$
wherein, sAT(x) represents the server alive time score, cRS(x) is the request strike score, sHS(x) represents the server health status score, (sRT) is a server response time threshold, sTLR (x) represents a time since a last response from the server, mRT represents a maximum request strike threshold, tSR represents the total request strike since a last server response, sLH(x) represents the last known server health status, and α, β, γ are weight factors for sAT(x), cRS(x), and sHS(x), respectively, wherein n represents a final time relative to initial time for which each factor is computed.

3. The system of claim 2, wherein the health score is computed based on the following expression:
$$Health Score = \frac{\sum sAT ( x ) + cRS ( x ) + sLHS ( x ) + ( λ * sHB ( x ) )}{4}$$
wherein sAT(x), cRS(x), sHS(x), sHB(x) are the plurality of factors, wherein sHB(x) represents the server heartbeat score and λ is weight factor of sHB(x).

4. The system of claim 1, wherein the criterion comprises determining a rate of change of the health score of the server.

5. The system of claim 1, wherein the weighted scores of the plurality of factors comprise:
calculating the server alive time score based on a server response time threshold and a last response timestamp;
calculating the request strike score based on a maximum request strike threshold and a total request strike since last server response; and
calculating the server health status score based on last known server health status.

6. The system of claim 1, wherein determining that the health score of the server meets the criterion comprises determining that the health score of the server is positive.

7. The system of claim 1, wherein determining that the health score of the server meets the criterion comprises determining that the health score of the server is equal to and/or above a threshold.

8. The system of claim 1, wherein a probe is sent to the server for determining metrics for each of the one or more parameters periodically.

9. The system of claim 8, wherein the probe is sent over a channel for determining the metrics for each of the one or more parameters and receiving the metrics over a same channel.

10. The system of claim 1, wherein determining that the health score of the server meets the criterion comprises calculating a server heartbeat score at a location physically remote from the server.

11. A system comprising:
a processor; and
a memory comprising computer program code, the memory and the computer program code configured to, with the processor, cause the processor to:
receive a transaction request from an entity;
determine metrics for one or more parameters for each of a first server and a second server;
compute a first health score of the first server based on the metrics of the first server and a second health score based on the metrics of the second server, wherein the first health score and the second health score is computed by calculating weighted scores of a plurality of factors based on the one or more parameters, and by averaging and summating the weighted scores of the plurality of factors;
compare the first health score and the second health score to determine a higher health score; and
send the transaction request to the first server or the second server based on the higher health score.

12. The system of claim 11, wherein the one or more parameters comprise a last server response timestamp, last known server health status, server heartbeat, a total request strike since last server response.

13. The system of claim 11, wherein the plurality of factors comprise a server alive time score, a request strike score, a server health status score, and a server heartbeat score.

14. The system of claim 13, wherein weighted scores of the plurality of factors comprise:
calculating the server alive time score based on a server response time threshold and a last response timestamp for each of the first server and the second server;
calculating the request strike score based on a maximum request strike threshold and a total request strike since last server response for each of the first server and the second server; and
calculating the server health status score based on last known server health status for each of the first server and the second server.

15. The system of claim 13, wherein the server heartbeat score is a number of remote procedure calls handled by the server in a predefined interval of time.

16. A computer storage medium has computer-executable instructions that, upon execution by a processor, cause the processor to at least:
receive a transaction request from an entity;
determine metrics for one or more parameters for each of a plurality of servers;
compute health scores for each of the plurality of servers based on the metrics for the one or more parameters, wherein the health score for each of the plurality of servers is computed by calculating weighted scores of a plurality of factors based on the one or more parameters, and by averaging and summating the weighted scores of the plurality of factors;
compare the health scores of each of the plurality of servers to determine a highest health score; and
transmit the transaction request to a server of the plurality of servers based on the highest health score.

17. The computer storage medium of claim 16, wherein a probe is sent to each of the plurality of servers for determining metrics for each of the one or more parameters for the plurality of servers.

18. The computer storage medium of claim 17, wherein the probe is sent over a channel to the plurality of servers for determining the metrics for each of the one or more parameters and receiving the metrics over a same channel.

19. The computer storage medium of claim 16, wherein a heartbeat of the plurality of servers is monitored using a periodic signal transmitted to each of the plurality of servers.

20. The computer storage medium of claim 16, wherein determining the health scores of the plurality of servers comprise:
calculating weighted scores for a plurality of factors using one or more parameters for each of the plurality of servers; and
averaging and summating the weighted scores of the plurality of factors for each of the plurality of servers.
